(19) United States
(12) Patent Application Publication
(10) Pub. No.: US 2006/0143025 A1
(43) Pub. Date: Jun. 29, 2006

(54) Live dissatisfaction alert & management system

(76) Inventors: Adrian Jeffery, Marietta, GA (US); Marc Jeffery, Seminole, FL (US)

Correspondence Address: Adrian Jeffery, 3130 Milford Chase, Marietta, GA, 30008, US

(21) Appl. No.: 11/019,998

(22) Filed: Dec. 23, 2004

(51) Int. Cl. G06Q 99/00

(52) U.S. Cl. 705/1

(57) ABSTRACT

A Dissatisfaction Alert and Management System and process for monitoring, Alerting and managing in real time negative Customer Experience's in retail and retail service environments. A system which Alerts clients in real time to poorly scoring pre-defined performance parameters flagged as important to a positive Customer Experience and Satisfaction with the pre defined programmatic preferred resolution strategy via e-mail. The system may be deployed singularly or throughout the enterprise and comprises an in situ Point of Experience (POE) appliance (referred to as a user process), a set of remote system processes existing with appropriate framework established to facilitate the real-time distribution of queries to one or more user processes independently and allow for the collection and analysis of their responses in real-time. A persistent means of storing all collected responses and the support framework which allows for automated or user-driven detailed Alert analysis and Alert report generation at any time, a persistent means of storing all queries and the required framework to facilitate their distribution to user processes, a method of monitoring query responses in real-time and issuing Alerts in real-time based on predefined parameters.

### PARENT CASE TEXT

This application claims benefit of provisional application No. 60/530,741 filed Dec. 20, 2003.

### FIELD OF THE INVENTION

The provisional application, which is incorporated herein in its entirety, discloses a System to accomplish in real time the monitoring of user responses and the generation of appropriate Alerts (directed to the client) when user responses satisfy predefined conditions that represent a level of dissatisfaction to a singular question or a plurality and allow the client to take instant, appropriate action on location based on predetermined designed intercept strategies.

### BACKGROUND OF THE INVENTION

As with most retail oriented businesses, collecting opinions from their most valuable assets, their customers, is imperative for the business to thrive and succeed. This is even more apparent in the service oriented sector, where the perception of quality and more critically customer satisfaction and the importance thereof, may be the only distinction between competitors vying for the same customer base with similar product offerings.

Conversely, in the past processes have been designed and implemented in attempts to measure customer satisfaction through varied forms of customer survey information metrics resulting with limited success and information that is removed in time and location from the problem area or areas, this is due greatly to the competing goals and limitations inherent in the processes. Statistically surveys are most accurate when every customer responds, in practice this is rarely attained, therefore sample sizes are calculated and those numbers are strived for, statistically tested and conclusions drawn about the population in general. However, these processes are impractical to implement on location or have no application in a retail environment. Furthermore, any process or system employed must not negatively impact the customers experience by being too long, too complex, or too intrusive if self administered onsite or at the location. This will not only add to a dissatisfactory experience but will also negatively impact the results. In an attempt to resolve these differences, the System or process should be visible, but not obtrusive or demanding; easy and simple or familiar to use; and comprehensive. It is the preferred embodiment of this System that negative responses or experiences could be relayed in real time to a delineated customer service agent and management on premises in an seamless manner, facilitating an immediate intercept with the customer to manage potentially adverse situations with a predetermined systemic customer service approach, prior to the customers departure from the retail environment.

The most prevalent and cost effective methodologies currently employed utilize the ubiquitous paper comment form or card. Post-card sized, they are made available to customers to be filled out and returned to a designated suggestion box for collection. This methodology, while widely implemented, is deficient in many ways, most importantly it is removed in time and location from the experience when the cards are actually compiled and tallied. Secondly there is an extremely low response rate that tends to create a misunderstanding of the customer experience climate. There are many other inherent deficiencies associated with this methodology and they are well known in the art. Furthermore this methodology is not interactive whereby questioned cannot be presented and the customer guided through the questionnaire. The questionnaire's that are completed, compiled and tallied may be difficult or slow to process. Universally, the data must be manually-entered into a program for analysis if any, or if at all. On occasion, machine-scannable, “check-box” forms are used, such as those of Datatron however these have proven to be error prone in the Industry and are again removed in time and location from the experience. Although this methodology is somewhat automated, this approach requires several days or weeks to process the surveys and even months for data presentation and the opportunity to act on those recorded experiences. This methodology as with telephone or direct mail questionnaires is acceptable for long-term forecasting, however it is removed in time and location and is inadequate for identifying and addressing immediately negatively reported customer experiences, concerns or deficiencies.

It is of note, that the prior art mechanisms, paper or semi-electronically based, are designed and engineered to be statistical, post experience survey methodologies. The questionnaires are administered either on location insitu or are post episodic and the analysis represents an insight into the climate weeks or months in the past and can only indicate past trends and delineate a potential levels of dissatisfaction that have occurred and are therefore not timely or really actionable from the point of view of retaining that disgruntled customer. Although this data has merit to management, the system does not facilitate a methodology incorporating a timely and as close to real time intercept with a preplanned management strategy to salvage the experience and turn it into a satisfied customer prior to leaving the retail environment.

The best form of advertising, good, bad, or otherwise is word of mouth. And it has been illustrated in the industry that a negative experience is 10 times more likely to be shared than a positive one. As outlined above the prior art can illustrate that trend, present that data weeks or months later and then attempt to resolve those issues in an effort to alter subsequent events, however that dissatisfied customer in all probability will not return and will share his/her dissatisfaction with friends, family and acquaintances.

More than one electronic survey mechanisms have been patented to try and address some of the aforementioned deficiencies. The automation of surveys eliminates much of the human error involved primarily with data entry and facilitates faster processing and report generation. However, nothing in the prior art provides for a web enabled, real time, self-administered, kiosk system, method, or device, or, more specifically, a system and process that can identify a dissatisfaction threshold, based on predetermined criteria, alert the proper on location attendant or attendants via e-mail, display to them the question, the respondents answer, and managements predetermined situational strategy course of action for the intercept prior to the customer exiting the establishment.

U.S. Pat. No. 4,345,315 to Cadotte et al is a simple mechanism for very basic surveying. The mechanism can present several questions and accept three or more alternative answers to each question. The answers are on written labels which are then inserted into the mechanism beside the response keys. It is a static product in a fixed location within an establishment and used as the customer is leaving.

U.S. Pat. No. 4,234,933 to Adelson et al discloses a device that incorporates a microprocessor-controlled slide projector to present a series of questions. Responses are given via a keyboard. It is a passive methodology with no provisions for immediacy.

U.S. Pat. No. 5,740,035 to Cohen et al discloses systems, methods, and mechanisms for electronic, self-administered surveys with the intent of gaining market information to be implemented at a later date by advertisers, advertising agencies, and broadcasters. The patent focuses on the storage of survey data in a plurality of survey mechanisms and the subsequent push of that data to a remote networked data processing unit. The thrust of the patent is the statistical and historical value of the survey data over time. The system is not online and in real time and therefore is unable to provide an alert situation to an on location attendant regarding a dissatisfied customer experience.

U.S. Pat. No. 6,380,928 to Todd discloses a portable, electronic survey mechanism designed to target the hospitality industry and more specifically restaurants. The system Incorporates a transceiver to alert restaurant personal pre-programmed criteria whether it be positive or negative that allows contact with the customer before they leave. The system is designed in a way that a plurality of these devices are utilized in the establishment and one device is brought to the customer upon presentation of their bill. This system utilizes RF technology although there is discussion of other analogue and digital technologies, the system incorporates a small alpha numeric display to present the questions and a keyboard to enter responses. The system in a preferred embodiment provides the manager of the restaurant with a silent pager to communicate a predefined value or an alert. The system is designed to be real time therefore allowing an intercept before the customer leaves the property. However this system is not web enabled and has limited scope in venues that are not restaurants or do not present some kind of bill to a paying customer. There is no provision of providing the alert via e-mail or to providing the alert to more than one on location attendant or to an offsite remote location such as a head office where these alerts could also be managed and monitored This system also has no provisions for presenting programmatically to the on location attendant or interceptor an alert containing the context of the question, the response given by the customer, and a pre defined management defined and approved situation strategy that could be initiated with the customer before they leave the premises. For example an offer of a reward or service upgrade etc. Therefore in a larger retail environment with many more variables this system cannot offer the flexibility to the management of custom programmatic and defined authoring of courses of action or strategies to manage dissatisfaction based on criteria that varies and programmatically and systematically address those deficiencies.

U.S. Pat. No. 6,381,744 to Nanos et al discloses an automated survey kiosk which is easily installed at a location, does not require access to standard telephone lines, and is easily reprogrammed. The automated survey kiosk for administering the survey incorporates a touch screen, a CPU, a modem etc and is well known to those skilled in the art. The patents thrust is the automation of the survey process, the programmability of a survey from a remote location and the collection and dissemination of survey data remotely. The system stores the survey responses locally in memory and utilizes a wireless modem for transmitting the survey responses to a remote location at predetermined intervals. The automated survey kiosk may be remotely reprogrammed with new questions, by altering existing questions or by deleting existing questions, from the location of the research firm, even while a respondent is answering the survey. The survey responses may be transmitted to the research firm, or may be directly sent to the client, who must be equipped with the proper equipment to communicate with the automated survey kiosk. Accordingly, the client can have almost instantaneous access to the latest survey data, and can modify the survey during the survey period. However with this invention there is no provision for the survey to be administered in real time via the web and there is no provision of providing an alert via e-mail to an on location attendant or interceptor containing the context of the question, the response given by the customer, and a pre defined management defined and approved situation strategy that could be initiated with the customer before they leave the premises.

With respect to the aforementioned inventions, it would be preferable to provide a web based online in real time self-administered survey system and process that is uncomplicated, and which programmatically monitors responses in real time and programmatically tags and identifies responses falling below a defined satisfaction threshold.

It would also be preferable to e-mail alerts in real time to an on location attendant or attendants or to an offsite remote location such as a head office where these alerts could also be managed, monitored and tracked by a regional manager or the like.

It would also be preferable to provide a survey system that sends an e-mail alert programmatically based on a response that indicates a level of dissatisfaction to the on location attendant or interceptor containing the context of the question, the response given by the customer, and a pre defined management defined and approved situation strategy that could be initiated with the customer before they leave the premises and are still conducting the survey.

It would also be preferable to provide a survey system that in a larger retail environment with many variables a system that can offer the flexibility to the management of custom programmatic and defined authoring of courses of action or strategies correlated with corporate initiatives or policies to manage dissatisfaction based on criteria that varies and programmatically and systematically address those deficiencies.

It would also be preferable to provide a singular survey system that has the ability to poll any customer at anytime, is centrally and easily located in a retail setting and is a stand alone unit.

### SUMMARY OF THE INVENTION

A Live Point of Experience Alert and Management System (herein referred to as ‘System’) for monitoring, measuring and Alerting in real time to negative Customer Experience's in retail and retail service environments and Alerting clients in real time to poorly scoring pre-defined performance parameters flagged as important to positive Customer Experience and satisfaction. The system may be deployed singularly or throughout the enterprise and comprises an in situ Point of Experience (POE) appliance (referred to as a user process), a set of remote system processes existing with appropriate framework established to facilitate the real-time distribution of queries to one or more user processes independently and allow for the collection and analysis of their responses in real-time. A persistent means of storing all collected responses and the support framework which allows for automated or user-driven detailed Alert analysis and Alert report generation at any time, a persistent means of storing all queries and the required framework to facilitate their distribution to user processes, a method of monitoring query responses in real-time and issuing Alerts in real-time based on predefined parameters.

Overall, the primary task of the System is to accomplish in real time the following: the monitoring of user responses and the generation of appropriate Alerts (directed to the client) when user responses satisfy predefined conditions and allow the client to take instant, appropriate action on location and/or actions based on these Alerts in the form of adding, deleting or supplementing a query or set of queries for a set of target POE devices/appliances, and being presented by the Alert with a list of predefined recommendations on courses of action based on the particular query and response to that query for a specific alert. The number of recipients of an alert is predefined and can be one or more, with no fundamental limit of the number. The design of the System is intended to achieve this task as efficiently and as close to instantaneously as possible within the context of which available and current technology permits.

As has been illustrated, the inherent disadvantages of the prior art can be realized with a web enabled online in real time system comprising an interactive, electronic, customer satisfaction survey mechanism. Such a system can by communicating in real time via e-mail transmissions remotely notify or alert customer service personnel to a respondents dissatisfaction before they leave the premises. The system's capacity for real time transmissions while the respondent is completing the survey permits immediate interaction with the respondent by allowing the customer service attendant to interact directly with the respondent and address and resolve issues on the premises.

The present invention embodies an interactive, online, electronic system comprising a web enabled kiosk known to those skilled in the art displaying in real time unique URL's comprising the programmatic features of administering, monitoring and managing the survey and related alert generation and transmissions. An monitoring and alerting capability in response to preprogrammed dissatisfaction threshold levels that initiates a transmission from the website to the designated targets or targets containing the context of the question, the response to the question and the preferred or designated intercept strategy to allow intervention in a customers service experience prior to that customers departure from the service establishment.

In the present invention, the criteria for triggering transmission of an alert e-mail message via the system web site, is a respondent's selection of a preprogrammed and tagged survey response or set of responses. However, the tag for initiating transmission of a message to a on location attendant is a survey respondent's response to a programmatic survey condition or set of conditions. In a further embodiment, the tag for initiating transmission of a message to a on location attendant is a survey respondent's achievement of an overall cumulative survey score or sub-set of scores equitable with a predefined threshold of satisfaction.

Other objects, features, and advantages of the present invention will become apparent to those skilled in the art from the following detailed description. It should be understood, however, that the detailed description and specific examples, while indicating preferred embodiments of the present invention, are given for purposes of illustration and not of limitation. Many changes and modifications within the scope of the present invention may be made without departing from the spirit thereof, and the invention includes all such modifications.

### BRIEF DESCRIPTION OF THE DRAWINGS

The preferred embodiments of the invention will become more readily understood as the present invention is more fully described in the following Description of Embodiments.

FIG. 1. System Process Overview Diagram is a schematic block diagram of the present invention illustrating the System Process.

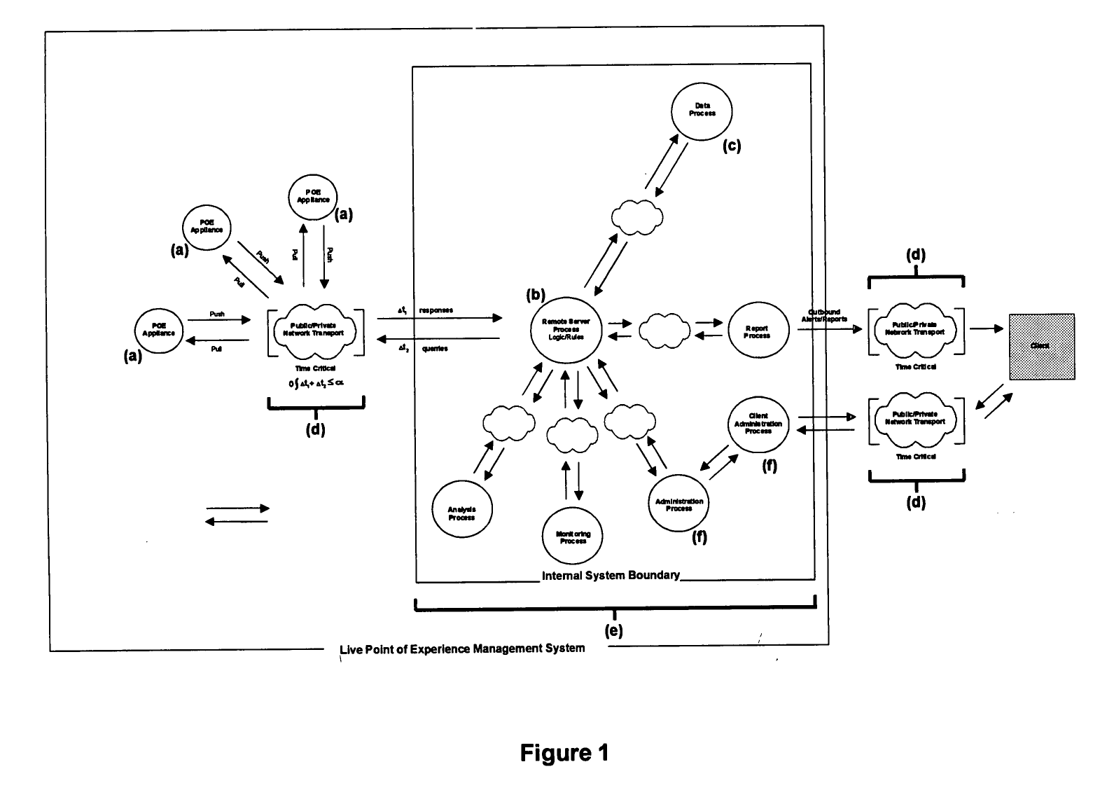

FIG. 2. System Time Flow Diagram is a schematic diagram of the present invention illustrating the System Time Flow design and architecture.

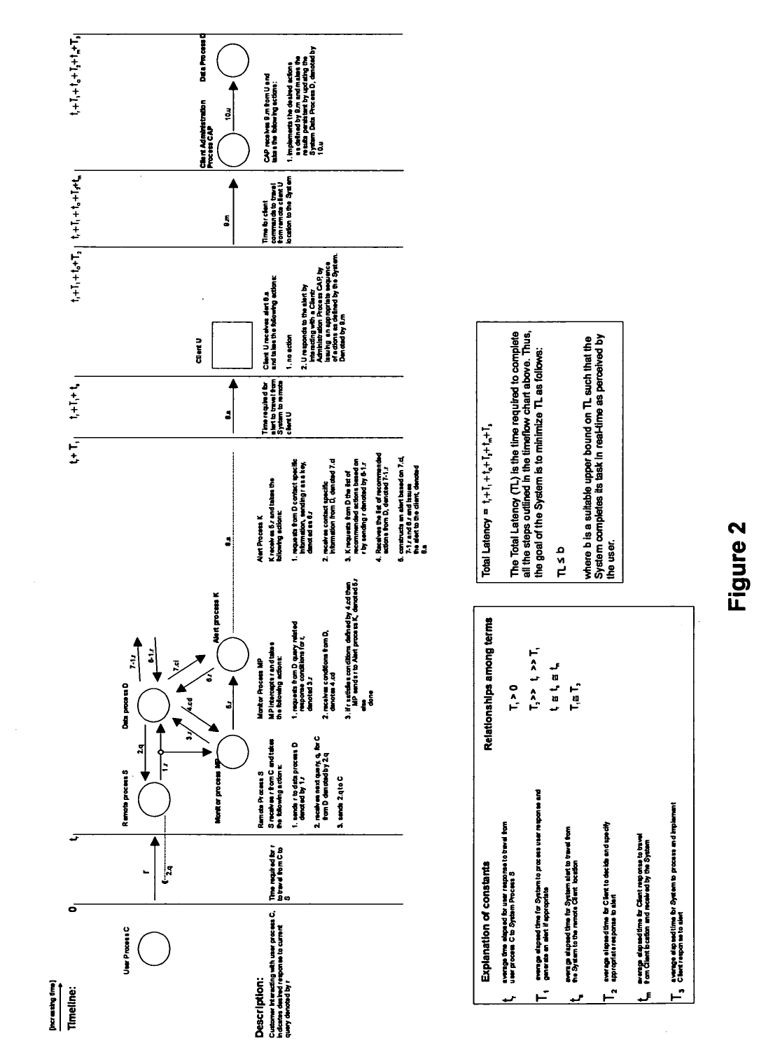

### DESCRIPTION OF EMBODIMENTS

The System (see System Diagram) is a methodology and process for monitoring, measuring and Alerting in real time Customer Experience's via a distributed, cooperative and concurrent process framework comprising: (A) an in situ Point of Experience (POE) user process or user processes (previously referred to as an appliance) for displaying in real time the intended query or queries related to measuring the customer experience (see (a) in System Diagram); (B) a remote server process or processes exist with the appropriate framework (see D) in place to facilitate a user process or processes to request (pull) a query or queries from a remote system process in real-time (see (b) in System diagram); (C) a remote system process or processes exist with the appropriate framework (see D) in place to facilitate a user process or processes to send a customer query response or responses to the system process or processes in real-time (see (b) in System diagram). (D) The System provides a means for uniquely assigning a specific survey or surveys and their related queries and responses to specific user processes in real time; The System is thus able to assign user process specific surveys, such that all queries and their responses can be specified and tracked for each and every user process independently from other user processes in real time (see (c) in System diagram). Additionally, this process/set of processes stores a set of ‘customer’ predefined courses of action based on the query and a given response to the query for the purposes of taking immediate action for customer service purposes.

A persistent communication channel established between the user process or processes (POE) and the remote system process or processes via a suitable network transport to facilitate real-time distribution of queries related data and the acquisition and collection of query responses and thus allow prompt action or actions be taken based on those responses in real time (see (d) in System diagram).

A suitable security policy is in place and enforced for all communications between any user process and remote system process and a suitable security policy is in place and enforced to allow only legitimate processes to establish communication with a user or system process. The system process or processes exist with the means to store in a persistent and secure fashion, all data related to a survey or surveys and their respective queries and related data including query responses (see (c) in System diagram);

Further there exists a framework of cooperative, concurrent and independent remote processes to facilitate the monitoring, analysis, administration and reporting of any and all data related to surveys and their related responses in adherence to specified client and programmatically defined constraints and parameters in real-time (see (e) in System diagram); An administrative framework (see administration process) exists to permit the design and modification of surveys and their related queries and set of possible responses programmatically in real-time with the ability to offer a plurality of customizable questions/queries regarding the services comprising but not limited to:
(i) location/time/date stamp data for the customer;
(ii) questions regarding their experiences;
(iii) concurrent means of measurement of satisfaction level;
(iv) specifying report and Alert criteria and constraints to permit the real time monitoring of query responses such that Alerts and reports can be generated and issued to defined designates (client contact or contacts) in real-time via automated email, phone, fax or other means as desired (see (f) in System diagram)

Further, an administrative framework exists that programmatically allows the creation and assignment of specific recommendations of action for customer service purposes to any defined query or set of queries based on the level of response for the given query or set of queries. Such predefined actions are sent in Alerts when their criteria are satisfied (see (f) in the System diagram)

In a preferred embodiment for the System for monitoring Customer Experience via an appliance or appliances in situ, the in situ appliance or appliances being connected to the remote system through a suitable network such as the Internet or private or leased network or networks or some combination of these (see (d) in System diagram). The in situ appliance or appliances connect with the network through either a physical interface such as a phone line or Ethernet, or through an air interface leveraging wireless network technologies such as WiFi.

Further, in the event that the network connection between the appliance and the remote system is severed or lost, the appliance enters a stand-by state that displays a suitable message or screen to inform the customer or customers that the survey is currently unavailable and to check back frequently, while at the same time attempting to reestablish a network connection. Significant efforts should be geared towards implementing a highly reliable network to maximize the usability of the appliance or appliances and thus maximize throughput of completed surveys. Furthermore, the System should include a mechanism by which network connectivity with appliances can be monitored so that problems, when they occur, can be identified and solved efficiently and in minimum time.

In a preferred embodiment the system comprises unique URL's contained in the www.opinion-bank.com domain or the like published on the WWW for the purpose of managing, monitoring and Alerting clients to Point of Experience deficiencies that can be addressed in real time.

Further, the System, in which the appliance receives a query in the form of a web page and associated data (images) requested from a remote web server, and the query response is generated from user interaction with the web page content, which then, the appliance sends the web page response to the remote web server for processing. All communication between the appliance and the remote web server is over a secure channel, such as SSL. The System incorporates the use of a web browser or similar software on the in situ appliance for the purposes of displaying and interacting with web pages, in which the web server works in parallel with a database for the purposes of retrieving appliance specific queries and storing customer responses, in conjunction a software process executes with the web server to identify and authenticate an appliance communicating with the web server for the purposes of retrieving queries and storing responses specific to that appliance.

Further, a software process (here called a filter) that executes within the context of the web server for the purposes of analyzing responses received from an appliance or appliances by comparing the response to a set of predefined conditions stored in the database in real-time. In parrallel a software process works cooperatively with the filter, whose purpose is to generate an Alert in real-time when indicated to do so by the filter. This process must obtain the appropriate client contact information from the database and then formulate the appropriate Alert. There can be one or more contact entries defined for a client, in this case the Alert is sent to each contact simultaneously. If the Alert is by email, then the software process connects to an SMTP server within the System to send an outgoing message with a suitable encryption level. If the Alert is by phone, the software process connects to a TAPI server within the System to generate the Alert.

Further, a software process executing within the context of the web server to provides a web interface for the client to efficiently and selectively modify and manage queries and conditional Alert requirements including modifying the list of recommended actions, on a per appliance and per query basis in real-time by modifying the appropriate data residing in the database via a rules based, controlled interface. This process has provisions to allow the client to generate Customer Experience Reports on demand with time, date and location of Alerts delineated, and requires a suitable authentication system executing in cooperation with the web server to identify and authenticate clients attempting to manage appliance resources such as queries and Alert criteria. Additionally, a data process or processes (Database) for compiling, reporting, storing and tagging defined performance parameters in addition to appliance specific queries, responses, recommended courses of action and Alert criteria.

The appliance, once installed, requires no in situ configuration to operate. Therefore there is no keyboard, or mouse. The appliances having a live connection, CPU, a memory, a browser, a display device and a touch screen interface overlayed on top of the display to act as the primary input.

What is claimed is:

1. The System is a methodology and process for monitoring, measuring and Alerting in real time Customer Experience's via a distributed, cooperative and concurrent process framework

2. The System wherein an in situ Point of Experience (POE) user process or user processes (previously referred to as an appliance) for displaying in real time the intended query or queries related to measuring the customer experience.

3. The System provides a means for uniquely assigning a specific survey or surveys and their related queries and responses to specific user processes in real time; The System is thus able to assign user process specific surveys, such that all queries and their responses can be specified and tracked for each and every user process independently from other user processes in real time.
A remote server process or processes exist with the appropriate framework in place to facilitate a user process or processes to request (pull) a query or queries from a remote system process in real-time
A remote system process or processes exist with the appropriate framework in place to facilitate a user process or processes to send a customer query response or responses to the system process or processes in real-time.

4. The System wherein the System provides a means for uniquely assigning a specific survey or surveys and their related queries and responses to specific user processes in real time; The System is thus able to assign user process specific surveys, such that all queries and their responses can be specified and tracked for each and every user process independently from other user processes in real time

5. A persistent communication channel established between the user process or processes (POE) and the remote system process or processes via a suitable network transport to facilitate real-time distribution of queries related data and the acquisition and collection of query responses and thus allow prompt action or actions be taken based on those responses in real time.
A suitable security policy is in place and enforced for all communications between any user process and remote system process.
A suitable security policy is in place and enforced to allow only legitimate processes to establish communication with a user or system process

6. A system process or processes wherein exist with the means to store in a persistent and secure fashion, all data related to a survey or surveys and their respective queries and related data including query responses

7. The System wherein a framework of cooperative, concurrent and independent remote processes to facilitate the monitoring, analysis, administration and reporting of any and all data related to surveys and their related responses in adherence to specified client and programmatically defined constraints and parameters in real-time

8. The System wherein an administrative framework exists to permit the design and modification of surveys and their related queries and set of possible responses programmatically in real-time with the ability to offer a plurality of customizable questions/queries regarding the services comprising but not limited to:
1. Location/time/date stamp data for the customer
2. Questions regarding their experiences; (iii) concurrent means of measurement of satisfaction level
3. Specifying report and Alert criteria and constraints to permit the real time monitoring of query responses such that Alerts and reports can be generated and issued to defined designates (client contact) in real-time via automated email, phone, fax or other means as desired.

9. A System for monitoring Customer Experience wherein via an appliance or appliances in situ, the in situ appliance or appliances being connected to the remote system through a suitable network such as the Internet or private or leased network or networks or some combination of these.

10. The System wherein the in situ appliance or appliances connect with the network through either a physical interface such as a phone line or Ethernet, or through an air interface leveraging wireless network technologies such as WiFi. In the event that the network connection between the appliance and the remote system is severed or lost, the appliance enters a stand-by state that displays a suitable message or screen to inform the customer or customers that the survey is currently unavailable and to check back frequently, while at the same time attempting to reestablish a network connection.

11. The System wherein the system comprises unique URL's contained in the www.opinion-bank.com domain or the like published on the WWW for the purpose of managing, monitoring and Alerting clients to Point of Experience deficiencies that can be addressed in real time.

12. The System wherein, the appliance receives a query in the form of a web page and associated data (images) requested from a remote web server, and the query response is generated from user interaction with the web page content, which then, the appliance sends the web page response to the remote web server for processing. All communication between the appliance and the remote web server is over a secure channel, such as SSL.
Implies the use of a web browser or similar software on the in situ appliance for the purposes of displaying and interacting with web pages.
The web server works in parallel with a database for the purposes of retrieving appliance specific queries and storing customer responses.
A software process executes with the web server to identify and authenticate an appliance communicating with the web server for the purposes of retrieving queries and storing responses specific to that appliance

13. The System wherein, a software process executes with the web server to identify and authenticate an appliance communicating with the web server for the purposes of retrieving queries and storing responses specific to that appliance.
Including a software process (here called a filter) that executes within the context of the web server for the purposes of analyzing responses received from an appliance or appliances by comparing the response to a set of predefined conditions stored in the database in real-time.

14. The System including a software process working cooperatively with the filter wherein, whose purpose is to generate an Alert in real-time when indicated to do so by the filter. This process must obtain the appropriate client contact information from the database and then formulate the appropriate Alert. If the Alert is by email, then the software process connects to an SMTP server within the System to send an outgoing message with a suitable encryption level. If the Alert is by phone, the software process connects to a TAPI server within the System to generate the Alert.

15. The System includes a software process executing within the context of the web server to provide a web interface for the client to efficiently and selectively modify and manage queries and conditional Alert requirements on a per appliance and per query basis in real-time by modifying the appropriate data residing in the database via a rules based, controlled interface.
Having provisions to allow the client to generate Customer Experience Reports on demand with time, date and location of Alerts delineated

16. The System wherein a data process or processes (Database) is implied for compiling, reporting, storing and tagging defined performance parameters in addition to appliance specific queries, responses and Alert criteria.
